(19) United States
(12) Patent Application Publication
(10) Pub. No.: US 2004/0054509 A1
(43) Pub. Date: Mar. 18, 2004

(54) System and method for preparing a solid model for meshing

(76) Inventors: Stephen R. Breit, Wayland, MA (US); Martin Bachtold, Brookline, MA (US); Bilge Kaan Karamete, Clifton Park, NY (US); Anqing Xu, Westwood, MA (US)

Correspondence Address: LAHIVE & COCKFIELD, LLP., 28 STATE STREET, BOSTON, MA, 02109, US

(21) Appl. No.: 10/242,097

(22) Filed: Sep. 12, 2002

(51) Int. Cl. G06G 7/48

(52) U.S. Cl. 703/4

(57) ABSTRACT

A system and method of applying a conformal mesh to selected parts of a solid model produced by a Computer Aided Design (CAD) system is disclosed. A graphical view of the solid model and a first and second symbolic view of the underlying data are presented to a user. User-selected parts of the solid model from one symbolic view are placed into a number of different mesh zones (areas where meshing procedures are later performed) in the second symbolic view for later decomposition into small elements. The illustrative embodiment of the present invention programmatically determines which of the user selected parts represent adjacent parts in the solid model being analyzed. Parts that are determined to be adjacent are placed in the same mesh zone prior to the meshing operation being performed. The placing of the adjacent parts in the same mesh zone assures that a conformal mesh is generated across the adjacent parts. The conformal mesh is used in performing three-dimensional numerical simulations such as finite element analysis which otherwise fail to produce correct results in the absence of a conformal mesh.

### FIELD OF THE INVENTION

The illustrative embodiment of the present invention relates generally to the field of Computer Aided Design (CAD) and more particularly to preparing a solid model in a CAD system for meshing operations.

### BACKGROUND OF THE INVENTION

Computer aided design (CAD) systems are used to produce computer models of two and three-dimensional objects prior to production of the actual physical device. CAD systems use data representing the geometrical shape and features of the object being modeled and present an illustration of the object on a display device to a user of the system. The three dimensional model or “solid model” may model a number of different types of objects including devices such as Micro Electrical Mechanical Systems (MEMS) devices or Microfluidics devices. The functionality of CAD systems has been extended to include not only producing a solid model of an object, but then simulating physical effects on it, such as deformations of its shape due to electrostatic forces, piezo-electric effects, or thermal expansion. Such simulations usually rely on a numerical method such as finite-element analysis, which takes as input not the solid model itself, but a mesh that is derived from the solid model. Typically, an automatic mesh generation procedure divides the arbitrary shapes represented by the solid model into smaller, simpler elements such as straight-sided tetrahedral and hexahedral, which are collectively known as a mesh. Conventional CAD systems allow a user to specify the mesh characteristics, run the meshing procedure, and then run a numerical simulation. By experimenting with different options and repeating this procedure, a user of the CAD system is able to save time and materials that would be otherwise spent in building physical representations of the object.

Unfortunately, the process of preparing a model for meshing in conventional CAD systems has some drawbacks. Numerical simulations based on finite element analysis tend to be very resource intensive from a computer standpoint, requiring considerable memory and processing time. These requirements can be reduced by meshing only the parts of the solid model that are of interest in a particular simulation. For instance, only the parts in the immediate vicinity of a heat source need to be meshed for a thermal simulation. In order to perform such a simulation, a user prepares the solid model by designating the parts to be meshed and then runs the meshing procedure. In preparing the solid model for meshing, it is not sufficient to simply designate the parts to be meshed. It is also necessary to designate parts that are adjacent so that the meshing procedure can produce a conformal mesh within those adjacent parts. A mesh is considered to be conformal if the geometrical union of the elements is equivalent to the original part or parts of the solid model, all elements in the mesh have non-empty interiors (i.e.: none are a point), and the intersection of any two elements in the mesh reduces to an empty set, a common vertex, a common edge, or a common face. Numerical simulation methods such as finite element analysis require a conformal mesh within adjacent parts. If the mesh is not conformal, the numerical simulation will not run to completion because it will encounter a numerical error such as a division be zero. Users are often unaware that adjacent parts should be grouped together during the meshing process. Moreover, it is often difficult if not impossible to determine purely by visual inspection that two parts are adjacent and therefore must be grouped together. As a result, a user must discover by trial and error whether the mesh is conformal, by repeatedly grouping parts, applying the meshing procedure, and attempting to run the simulation.

### SUMMARY OF THE INVENTION

The illustrative embodiment of the present invention allows a conformal mesh to be generated on selected parts of a solid model produced by a CAD system. A graphical view of the solid model and a first and second symbolic view of the underlying data are presented to a user. User-selected parts of data from one symbolic view are placed into a number of different mesh zones (areas where meshing procedures are later performed) in the second symbolic view for later decomposition into small elements. The illustrative embodiment of the present invention programmatically determines which of the user selected parts represent adjacent parts in the solid model being analyzed. Parts that are determined to be adjacent are placed in the same mesh zone prior to the meshing operation being performed. The placing of the adjacent parts in the same mesh zone allows a conformal mesh to be generated across the adjacent parts, resulting in a mesh that is suitable for three dimensional numerical analysis.

In one embodiment of the present invention, a method of using a CAD system provides a data source holding data which indicates features and dimensions of a three dimensional object being modeled by the CAD system. A user of the CAD system is presented with a display which includes a graphical view of the solid model and a first and second symbolic view of the data. The first symbolic view displays labels of parts of the solid model. The second symbolic view displays labels of selected parts of the three dimensional object which have been selected for meshing from the first symbolic view. A label from one of the parts is selected from the first symbolic view and displayed in the second symbolic view in a mesh zone.

In another embodiment of the present invention, a CAD system includes a data source holding data which indicates features and dimensions of a three dimensional object being modeled by the CAD system. The CAD system also includes a display means for presenting an illustration of the three dimensional object to a user. The display of the information to the user includes a first and second symbolic view, where the first symbolic view displays labels corresponding to parts of the three dimensional object data and the second symbolic view displays a meshing model for the data, the meshing model displaying labels of parts selected from the first symbolic view. A graphical view of the three dimensional object is also presented to the user.

In a different embodiment of the present invention, a method of using a CAD system provides a data source holding data which indicates features and dimensions of a physical object being modeled by the CAD system. A user of the CAD system is presented with a display which includes a graphical view of the solid model and a first and second symbolic view of the data. The first symbolic view displays labels of parts of the solid model. The second symbolic view displays labels of selected parts of the object which have been selected for meshing from the first symbolic view. A label from one of the parts is selected from the first symbolic view and displayed in the second symbolic view in a mesh zone.

### BRIEF DESCRIPTION OF THE DRAWINGS

FIG. 1 depicts an environment suitable for practicing an illustrative embodiment of the present invention;

FIG. 2A depicts a block diagram of the display of a graphical view of the solid model and first and second symbolic views of the solid model data to a user prior to selecting parts to undergo meshing procedures;

FIG. 2B depicts the block diagram of the display of FIG. 2A after the user has selected several parts of the data from the first symbolic view for meshing; and

FIG. 3 is a flow chart depicting the sequence of steps followed by the illustrative embodiment of the present invention to programmatically determine adjacent parts in a solid model prior to performing meshing procedures.

### DETAILED DESCRIPTION

The illustrative embodiment of the present invention provides a pre-processor application for use with a solid model produced by a CAD system. The pre-processor application pre-processes the data from the solid model to allow a conformal mesh to be generated on selected parts of the solid model. A conformal mesh is used in performing the subsequent three-dimensional numerical simulations of physical effects. A graphical view of the solid model and a first and second symbolic view of the solid model data are presented to the user. In order to prepare the solid model for meshing, the user designates parts of the solid model from the first symbolic view or from the graphical view that are to be added to the second symbolic view. The pre-processor then programmatically determines which of the designated parts are adjacent, and groups them into zones in the second symbolic view. When the user has finished designating all parts that are to be meshed, the user invokes the mesh generation procedure. The programmatic placing of the adjacent parts into the same mesh zone assures that a conformal mesh is generated across the adjacent parts.

Solid models or three-dimensional models in a CAD system consist of mathematical descriptions of the geometrical shapes that make up a device, such as a MEMS device or microfluidics device. The actual fabrication of a MEMS device or a microfluidics device is an extremely expensive, time-consuming process. Accordingly, CAD systems are used to simulate a virtual model of a device prior to construction of the actual physical device (the construction of other types of devices also benefits from production of a virtual model prior to building a physical model). Since three-dimensional numerical simulation tends to be very processor intensive for the computer or electronic device performing the processing, the simulations are often performed on a subset of the geometrical parts that comprise the device. The illustrative embodiment of the present invention allows the user to designate the parts that are to be simulated and then programmatically groups the designated parts into mesh zones based on their location in the solid model. Adjacent parts are included in the same mesh zone so that the meshing process results in a conformal mesh which is used in performing numerical simulation methods such as finite element analysis. The programmatic grouping of adjacent parts into the same mesh zone frees the user from having to know that the parts should be assigned to the same mesh zone for analysis.

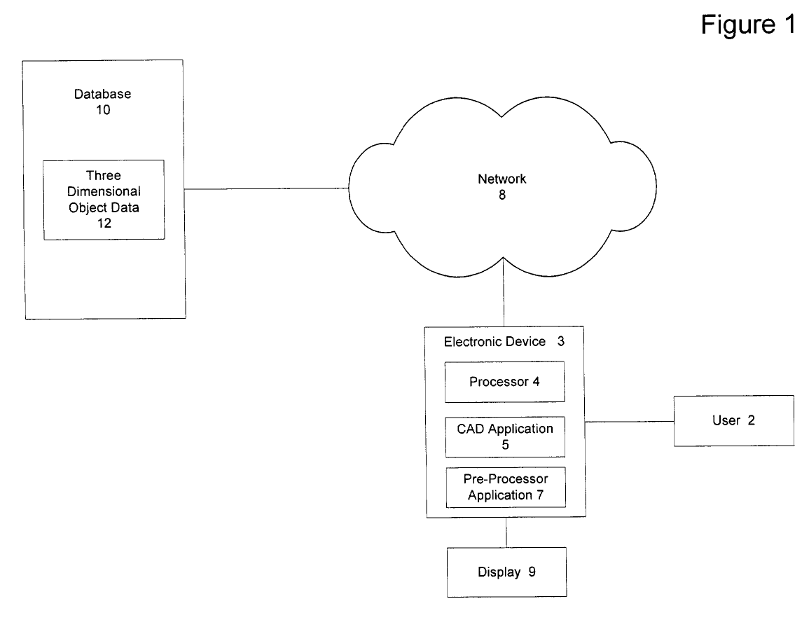

FIG. 1 depicts an environment suitable for practicing an illustrative embodiment of the present invention. A user 2 accesses an electronic device 3. The electronic device 3 may be a server, desktop system, workstation or other type of electronic device. The electronic device 3 includes a processor 4. The processor 4 is used to execute a CAD application 5 and a pre-processor application 7 which are held in a storage medium on the electronic device 3. The electronic device 3 is interfaced with a display 9 and a network 8. The display 9 is viewable by the user 2. Also interfaced with the network 8 is a database 10. The database 10 holds data 12 used by the CAD system 5 to generate illustrations of three-dimensional objects. Those skilled in the art will recognize that the database 10 may be located in a number of different locations including on the electronic device 3. Similarly, the CAD application 5 may be located at an alternative location accessible over the network 8. The electronic device 3 retrieves the three dimensional object data 12 from the database 10 over the network 8 The three dimensional object data 12 is used by the pre-processor application 7 to generate a graphical view of the three dimensional solid model and a first and second symbolic view of the underlying data which are presented to the user 2 via the display 9. Those skilled in the art will recognize that other networked and non-networked environments utilizing alternative topographies and architectures are also possible within the scope of the present invention.

The CAD application 5 is used to produce a mathematical representation of the physical object being modeled, the “solid model”. The solid model and resulting mesh of the solid model each have a specific hierarchy of entities. The solid model includes one or more parts. Each of the parts is enclosed by faces. Each face is bordered by edges. Each edge is terminated by two vertices. Similarly, each mesh includes one or more zones. Each mesh zone contains one or more elements. Each element contains four or more element faces which are bordered by three or more element edges. Each of the element edges is terminated by two nodes. Those skilled in the art will recognize however that other hierarchies of entities are possible without departing the scope of the present invention.

In one embodiment, the various features and geometrical data from the solid model and the mesh are stored in a model-mesh database. The model-mesh database tracks relationships between the entities of the solid model, and between the mesh entities and the solid model entities. In other words, the relationships among the various parts, faces, edges and vertices used to generate the solid model are stored in the mesh database. The mesh database may hold a collection of different types of data structures, vectors, linked lists, etc. which contain the entity data and relationships. The mesh database may be an Algorithm Oriented Mesh Database (AOMD) holding a subset of dynamically chosen relationships (from the entire set of entity relationships) which are relevant to an ongoing numerical analysis. The AOMD database may be overlaid on an underlying relational database. The AOMD database holds pointers from the various entity data to the solid model and to the mesh model.

The first symbolic view displayed by the pre-processor application 7 presents the three-dimensional data 12 used to present the solid model to a user 2. The data is grouped into categories assigned by the CAD application 5. The data appears in a tree-like structure with labels corresponding to various parts of the three dimensional data 12. The tree may be produced from commercially available software packages such as those provided by Microsoft Corporation of Redmond, Wash. The tree and different views utilized by the illustrative embodiment of the present invention may be manipulated by well-known input methods, such as mouse click captures tied to message handlers in the pre-processing application 7 or similar methods. The data is retrieved from objects stored in the three dimensional data location in the database 10. Those skilled in the art will recognize that non-object oriented formats may be used to store the data without departing from the scope of the present invention. Each of the parts/labels is cross-referenced with the solid model being displayed in the graphical view so that if the user 2 clicks on the label in the tree to highlight the label, the corresponding part of the solid model is also highlighted. Similarly, if the user 2 clicks on a part of the solid model in the graphical view, the corresponding part label in the first symbolic view is highlighted.

The second symbolic view produced by the pre-processor application 7 is the mesh model and is initially presented to the user 2 as an empty tree. As the user selects parts, either individually or in groups, the parts are placed into the tree. The second symbolic view includes mesh zones as initial branches of the tree. Mesh zones are groupings of selected parts that are to be meshed when the user invokes the meshing procedure. Each part from the first symbolic view that is selected by the user appears in one mesh zone in the second symbolic view. The illustrative embodiment of the present invention groups each selected part that is adjacent to a previously selected part in the solid model into the same mesh zone in the second symbolic view. The second symbolic view is also cross-referenced with the graphical view so that any selection of a part/label from the second symbolic view causes the corresponding part of the solid model to be highlighted in the graphical view. When the user 2 selects a part of the solid model in the graphical view, the corresponding part/label is highlighted in the second symbolic view if the part/label has been added to the meshing model, rather than the first symbolic view. The message handler for the graphical view 14 is adjusted by the pre-processor application 7 when a part from the first symbolic view is added to the second symbolic view. Thereafter, the message handler capturing the mouse click or other input in the graphical view 14 ignores the label in the first view and highlights the label in the second view for future mouse clicks. Those skilled in the art will recognize that the multiple views used by the illustrative embodiment of the present invention may be cross-referenced using a number of different programming techniques without departing from the scope of the present invention. In one embodiment, the first and second symbolic views may be combined into a single tree. In another embodiment, the symbolic views may be placed into separate frames on the display device.

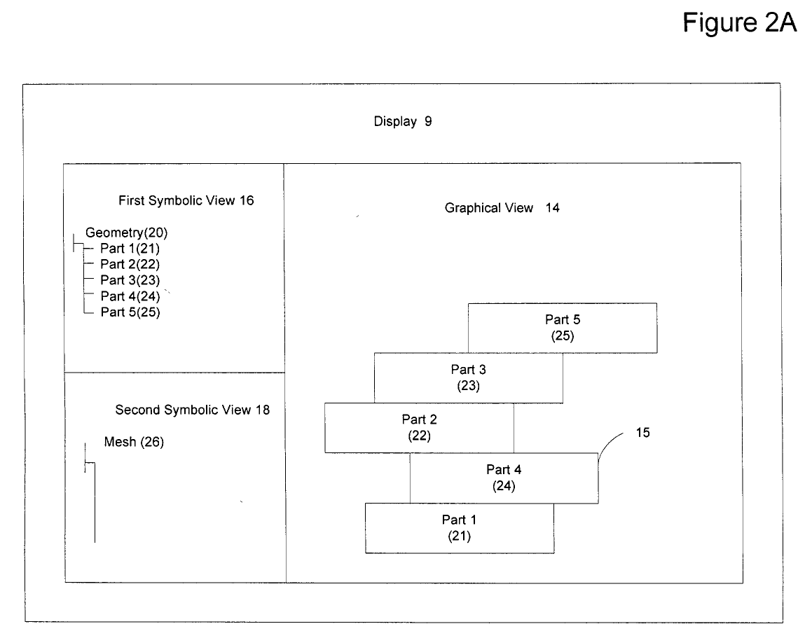

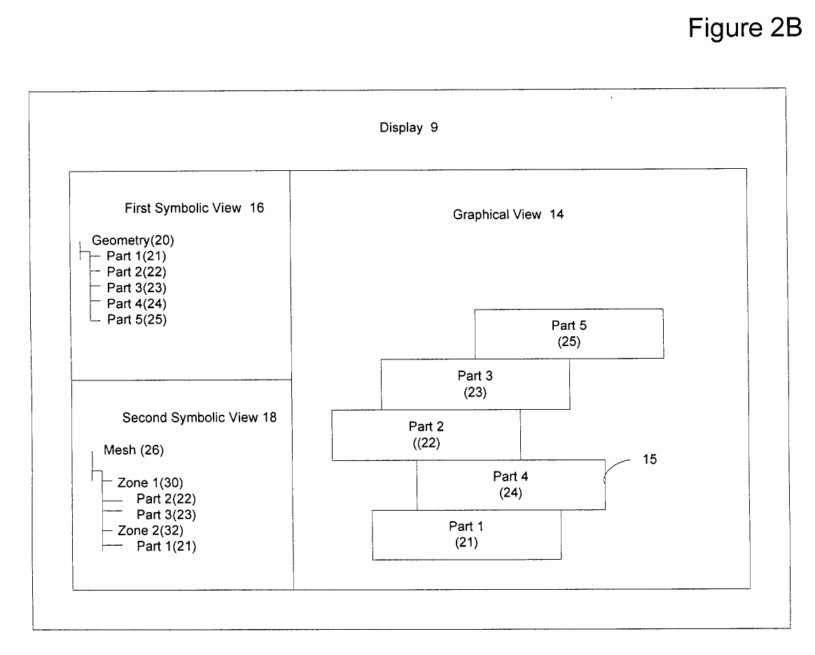

FIG. 2A depicts a block diagram of the display 9, displaying a graphical view 14, a first symbolic view 16 and a second symbolic view 18. The graphical view 14 displays an illustration of a solid model 15 derived from the three dimensional object data 12. The first symbolic view 16 displays the parts labels for the three dimensional object data 12. The first symbolic view 16 includes part 1 (21), part 2 (22), part 3 (23), part 4 (24) and part 5 (25), all of which have their corresponding parts in the solid model in the graphical view 14. Those skilled in the art will recognize that the number of parts appearing in the view will vary depending upon the object being modeled. The three dimensional object data 12 includes geometric data indicating the positioning of the various elements of the object being modeled and feature data of the various features of the object being modeled. The second symbolic view 18 is the meshing model and indicates the parts that have been selected by the user 2 for meshing procedures. Upon retrieval of the three dimensional object data 12 and the initial generation of the graphical view 14, first symbolic view 16, and second symbolic view 18, all of the parts that comprise the object appear only in the first symbolic view 16. The second symbolic view 18 only becomes populated following user selection of one or more parts from the first symbolic view 14.

FIG. 2B is a block diagram representing the display 9 of FIG. 2A at a later point in time following user selections of parts to be meshed. The graphical view 14 is unchanged from the previous view. The first symbolic view 16 includes part 1 (20), part 2 (22), part 3 (23), part 4 (24) and part 5 (25). The second symbolic view 18 now includes a mesh zone 1 label 30 and a mesh zone 2 label 32. The user 2 has selected three parts of the three dimensional object data 12 to undergo a meshing procedure prior to performing three-dimensional numerical simulations. Part 2 (22) and part 3 (23) appear as labels under the mesh zone 1 (30) label. Part 1 (21) appears under the mesh zone 2 (32) label. The illustrative embodiment of the present invention automatically assigns part 2 and part 3 to the same mesh zone, mesh zone 1 (30), because the parts represent adjacent geometrical regions in the solid model 15 as indicated in the graphical view 14. By grouping immediately adjacent parts of the three dimensional object data 12 into the same mesh zone, the illustrative embodiment of the present invention enables the meshing procedure to generate a conformal mesh throughout both parts. A conformal mesh is used in performing three-dimensional numerical simulation methods such as finite element analysis. Such methods fail to produce correct results if the mesh is not conformal. The solid model parts visible in the graphical view 14 are cross referenced with the three parts 21, 22, and 23 in the second symbolic view 18 and the two parts 24 and 25 in the first symbolic view 16. The three parts 21, 22 and 23 that appear in the second symbolic view 18 also appear in the first symbolic view 16, but are grayed out or otherwise marked as unselectable for the user, and their cross-references disabled.

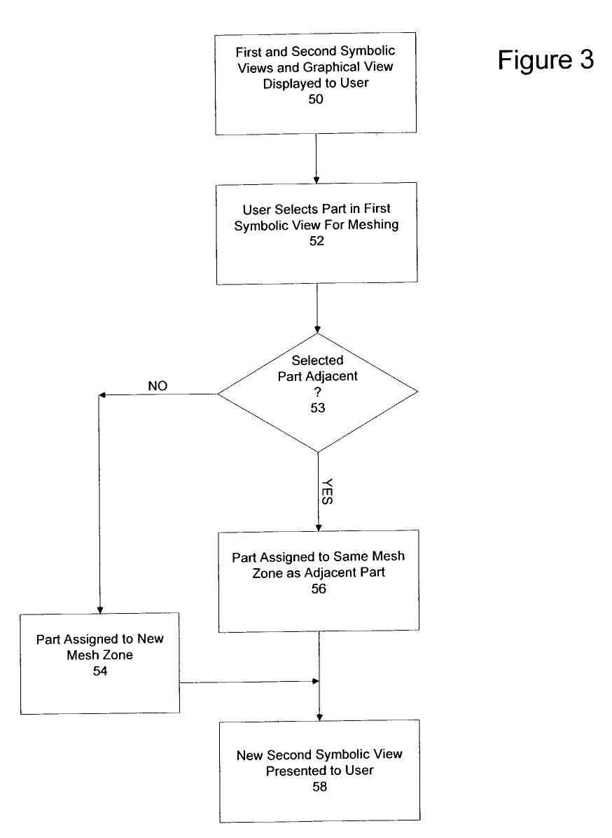

FIG. 3 depicts a flowchart of a sequence of steps followed by the illustrative embodiment of the present invention to assign parts of the solid model 15 to a mesh zone for subsequent meshing procedures. The sequence begins when a first and second symbolic view 16 and 18 and a graphical view 14 are generated and displayed to the user (step 50). The first symbolic view 16 includes labels for different parts of the three dimensional object data 12. The user selects specific parts of the three dimensional object data 12 that appear in the first symbolic view to undergo meshing procedures before subsequent three-dimensional analysis (step 52). The selection process may be made by a drag and drop procedure from the first symbolic view 16 into the second symbolic view 18 or may be made via a menu selection or other manner of indicating a selection. The illustrative embodiment of the present invention programmatically determines whether the selected part is adjacent to a previously selected part (step 53). If the selected part from the first symbolic view 16 is not adjacent to another part in the solid model 15, the selected part is placed in a new mesh zone in the second symbolic view 18 (step 54). Alternatively, if the selected part is determined to be adjacent to another part previously selected to undergo additional meshing procedures, the part is assigned to the same mesh zone as the previously selected adjacent part (step 56). Once the selected parts have been placed into the second symbolic view 18, the second symbolic view is displayed for the user 2 (step 58). The selection of the parts and display of the parts in the second symbolic view 18 affords the user an opportunity to provide final approval prior to the meshing operation actually being carried out.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. For example, the illustrative embodiment of the present invention may be practiced without the use of a network on a non-networked system. Similarly, while the illustrative embodiment of the present invention has been described with reference to analysis of three dimensional objects, the present invention is equally applicable to two dimensional objects. Practitioners of the art will realize that the sequence of steps and architectures depicted in the figures may be altered without departing from the scope of the present invention and that the illustrations contained herein are singular examples of a multitude of possible depictions of the present invention.

We claim:

1. In a Computer Aided Design (CAD) system, a method, comprising the steps of:
providing a data source holding data, said data indicating features and dimensions of a three dimensional object;
displaying a graphical view of said three dimensional object and a first and second symbolic view of said data to a user, said first symbolic view displaying labels of parts of said three dimensional object data, said second symbolic view displaying a meshing model for said data, said meshing model displaying labels of selected parts of said three dimensional data from said first symbolic view, said selected parts selected for decomposition into smaller elements; and
displaying a first and second label of said parts of data from said first symbolic view in said second symbolic view; and
determining programmatically a mesh zone for said first and second label within said second symbolic view, each said mesh zone holding at least one of said parts of data of said three dimensional object.

2. The method of claim 1 wherein said second label is displayed in the same mesh zone as said first label as a result of a determination that said first and second labels reference immediately adjacent parts in said three dimensional object.

3. The method of claim 1 wherein said second label is displayed in a different mesh zone from said first label as a result of a determination that said first and second labels do not reference immediately adjacent parts in said three dimensional object.

4. The method of claim 1 wherein said labels displayed in said first and second symbolic views are synchronized with their referenced parts displayed in said three dimensional object displayed in said graphical view.

5. The method of claim 1, comprising the further step of:
meshing said parts referenced by said labels displayed in said mesh model after receiving instructions from a user, meshing being the decomposition of said parts into smaller elements.

6. The method of claim 5, comprising the further step of:
performing a numerical analysis on the three dimensional data contained in said smaller elements.

7. The method of claim 5 wherein the meshing produces a conformal mesh, said conformal mesh producing identical division lines across parts of said three dimensional object.

8. The method of claim 1 wherein said CAD system is used to model a Micro Electrical Mechanical System (MEMS) device.

9. The method of claim 1 wherein said three dimensional object is a microfluidics device.

10. A Computer Aided Design (CAD) system, comprising:
a data source holding data indicating features and dimensions of a three dimensional object;
a display device, said display device presenting said data to a user of said system and including:
a first and second symbolic view, said first symbolic view displaying labels of parts of said three dimensional object data, said second symbolic view displaying a meshing model for said data, said meshing model displaying labels of selected parts of said three dimensional data from said first symbolic view, said selected parts selected for decomposition into smaller elements; and
a graphical view of said three dimensional object;
a processor, said processor programmatically determining mesh zones within said second symbolic view, said mesh zones each holding at least one of said parts of data of said three dimensional object selected for decomposition into smaller elements.

11. The system of claim 10 wherein a label from said first symbolic view is displayed in said second symbolic view.

12. The system of claim 10 wherein said display device displays labels referencing parts determined to be immediately adjacent parts in said three dimensional object in the same mesh zone.

13. The system of claim 10 wherein said display device displays labels referencing parts determined not to be immediately adjacent parts in said three dimensional object in different mesh zones.

14. The system of claim 10 wherein said processor performs a conformal mesh of said parts referenced by the labels displayed in said second symbolic view, said conformal mesh producing identical division lines across parts of said three dimensional object.

15. In a Computer Aided Design (CAD) system including a medium, said medium holding computer-executable steps for a method, said method comprising the steps of:
providing a data source holding data, said data indicating features and dimensions of a three dimensional object;
displaying a graphical view of said three dimensional object and a first and second symbolic view of said data to a user, said first symbolic view displaying labels of parts of said three dimensional object data, said second symbolic view displaying a meshing model for said data, said meshing model displaying labels of selected parts of said three dimensional data from said first symbolic view, said selected parts selected for decomposition into smaller elements; and
displaying a first label of one of said parts of data from said first symbolic view in said second symbolic view.

16. The medium of claim 15 wherein said method comprises the further steps of:
displaying a second label of one of said parts of data from said first symbolic view in said second symbolic view, and
determining programmatically a mesh zone for said first and second label within said second symbolic view, each said mesh zone holding at least one of said parts of data of said three dimensional object.

17. The medium of claim 16 wherein said method comprises the further step of:
meshing said parts referenced by the labels displayed in said second symbolic view after receiving instructions from a user, meshing being the decomposition of said parts into smaller elements.

18. The medium of claim 17 wherein said method performs a conformal mesh, said conformal mesh producing identical division lines across parts of said three dimensional object.

19. In a Computer Aided Design (CAD) system, a method, comprising the steps of:
providing a data source holding data, said data indicating features and dimensions of a an object;
displaying a graphical view of said object and a first and second symbolic view of said data to a user, said first symbolic view displaying labels of parts of said object data, said second symbolic view displaying a meshing model for said data, said meshing model displaying labels of selected parts of said data from said first symbolic view, said selected parts selected for decomposition into smaller elements; and
displaying a first and second label of said parts of data from said first symbolic view in said second symbolic view; and
determining programmatically a mesh zone for said first and second label within said second symbolic view, each said mesh zone holding at least one of said parts of data of said object.

20. The method of claim 19 wherein said second label is displayed in the same mesh zone as said first label as a result of a determination that said first and second labels reference immediately adjacent parts in said object.

21. The method of claim 19 wherein said second label is displayed in a different mesh zone from said first label as a result of a determination that said first and second labels do not reference immediately adjacent parts in said object.
